(19) United States
(12) Patent Application Publication
(10) Pub. No.: US 2015/0316187 A1
(43) Pub. Date: Nov. 5, 2015

(54) HOLDING DEVICE FOR PIPE JOINT AND PIPE JOINT USING SAME

(71) Applicant: M.K. KIKAKU.,CO.LTD, Tokyo (JP)

(72) Inventor: AKIO MATSUBARA, TOKYO (JP)

(21) Appl. No.: 14/443,736

(22) PCT Filed: Oct. 31, 2013
(86) PCT No.: PCT/JP2013/079488

§ 371 Date: May 19, 2015

(30) Foreign Application Priority Data
Nov. 22, 2012 (JP) 2012-256391

(51) Int. Cl. F16L 25/00; F16L 19/04; F16L 21/00

(52) U.S. Cl. CPC F16L 25/0054; F16L 21/007; F16L 21/00; F16L 19/041

(57) ABSTRACT

A holding unit (6) according to the invention is applied to a corrugated pipe (1) to prevent accidental disconnection of a pipe joint (2). The holding unit (6) includes a first holder (7). The first holder (7) has a ridge (71) protruding from the outer surface of a cylindrical base (70) and is received on the inner surface of a protrusion (P1) of the corrugated pipe (1). A notch (73) extends along the axial direction (L) of the cylindrical base (70).

### TECHNICAL FIELD

The present invention relates to a pipe-joint holding unit and a pipe joint including the holding unit, in more specific, a pipe-joint holding unit to be attached to a connecting end of a corrugated pipe in a water supply system and a pipe joint including the holding unit.

### BACKGROUND ART

In general, buildings are equipped with water supply systems for feeding water from distributing pipes buried under roads by water suppliers to owners of the buildings (consumers). The water supply systems each includes feeding pipes branching from a distributing pipe and water fixtures directly connected to the feeding pipes. For example, water from the distributing pipe flows through the feeding pipes arranged in a building to water fixtures such as faucets.

In recent years, the feeding pipes have been flexible corrugated pipes fabricated through the corrugation on metal pipes, such as stainless-steel pipes. Such flexible corrugated pipes can be readily bent and can thus be efficiently arranged in a desired feeding-pipe formation. The arrangement of feeding pipes requires the connection of multiple corrugated pipes on the basis of specific conditions, such as the structure and the scale of the building. Since the feeding pipes are arranged inside the building as described above, the corrugated pipes must be connected to certainly prevent water leakage at their joint.

In order to meet this requirement for the water-tightness, for example, PTL 1 discloses a pipe joint. The pipe joint disclosed in PTL 1 includes a nut, a socket, and a stopper ring. The stopper ring is fitted on the outer surface of a depression of a corrugated pipe. The connecting end of the corrugated pipe is received in the nut that is engaged with the stopper ring and is screwed to the socket.

In the measures for preventing water leakage in such water supply systems, earthquakes are seriously problematic. Most of the distributing pipes are under the management of water suppliers and are prepared by them for earthquakes, whereas most of the feeding pipes are under the management of consumers and are not fully prepared for earthquakes. For example, in the case of accidental disconnection of a pipe joint from a feeding pipe due to a distortion of the building during an earthquake, consumers cannot receive water despite of no water leakage in distributing pipes. Furthermore, since the feeding pipes are often arranged inside walls or beneath the floor of the building, it takes a long time to specify the disconnected position of the pipe joint from outside the walls or above the floor and to reconnect the feeding pipes.

Unfortunately, the technique disclosed in PTL 1 cannot meet the requirement for the water-tightness against earthquakes. In specific, the flexible corrugated pipe is unintentionally deformed by tensile force in response to a distortion of the building during an earthquake, so that the corrugated wall of the pipe is stretched out in the axial direction, leading to a reduction in diameter of the corrugated pipe. The unintentional deformation releases the stopper ring from the corrugated pipe, so that the stopper ring, the nut engaging with the stopper ring, and the socket screwed to the nut are all disconnected from the joint of corrugated pipes.

### CITATION LIST

### Patent Literature

PTL 1: JP 2005-325933A

### SUMMARY OF INVENTION

### Technical Problem

An object of the invention is to provide a pipe-joint holding unit that can prevent accidental disconnection of a pipe joint, and a pipe joint including the holding unit.

### Solution to Problem

A pipe-joint holding unit according to the invention, which has been accomplished to achieve the above object, includes a first holder. The first holder has a ring segment received on the inner surface of a protrusion of a corrugated pipe.

The holding unit according to the invention is assembled with a socket and a nut into a pipe joint for corrugated pipes. In specific, the nut of the pipe joint according to the invention is attached on the outer surface of the corrugated pipe and is coupled to the socket. The first holder of the holding unit is disposed between the nut and the socket.

In the pipe joint according to the invention, the nut on the outer surface of the corrugated pipe is coupled to the socket, as described above. The socket can be further coupled to another corrugated pipe so as to connect multiple corrugated pipes together.

The above-described structure is also employed in traditional pipe joints. Unfortunately, the traditional pipe joints cannot prevent the disconnection of the stopper ring, the nut engaging with the stopper ring, and the socket coupled to the nut, from the flexible corrugated pipe. As described above, the disconnection is caused by an unintentional deformation of the corrugated pipe caused by tensile force in response to a distortion of the building during an earthquake, which leads to the stretch of the corrugated wall of the pipe in the axial direction; a reduction in diameter of the corrugated pipe; and then the release of the stopper ring, which is normally engaged with the nut and is fitted on the outer surface of a depression of the corrugated pipe, from the corrugated pipe.

The invention can provide a pipe-joint holding unit without the trouble. In specific, the pipe-joint holding unit according to the invention includes a first holder having a ring segment received on the inner surface of a protrusion of a corrugated pipe. The first holder can support the corrugated pipe against tensile force thereto, to prevent an unintentional deformation of the corrugated pipe. The pipe-joint holding unit having such a configuration and a pipe joint including the holding unit can prevent accidental disconnection of the pipe joint.

### Advantageous Effects of Invention

The invention can provide a pipe-joint holding unit that can prevent accidental disconnection of a pipe joint, and a pipe joint including the holding unit, as described above.

Other objects, configurations, and advantages of the invention will be described in more detail with reference to the accompanying drawings. It is noted that the drawings are merely given illustrative purposes.

### BRIEF DESCRIPTION OF DRAWINGS

FIG. 1 is a partial cross-sectional view of a pipe joint according to an embodiment of the invention;

FIG. 2 is an exploded view of the internal structure of the pipe joint illustrated in FIG. 1;

FIG. 3 is a perspective view of the first holder illustrated in FIG. 2;

FIG. 4 is a plan view of the first holder illustrated in FIG. 3;

FIG. 5 is a cross-sectional view of the assembly of the first and second holders illustrated in FIG. 2;

FIG. 6 is a plan view of the third holder illustrated in FIG. 2;

FIG. 7 is a cross-sectional view along a line 7-7 in FIG. 6;

FIG. 8 is a partial cross-sectional view of the main configuration of the pipe joint described with reference to FIGS. 1 to 7 for illustrating an application mode of the pipe joint; and

FIG. 9 is a partial cross-sectional view of the main configuration of a traditional pipe joint for illustrating an application mode of the pipe joint.

### DESCRIPTION OF EMBODIMENTS

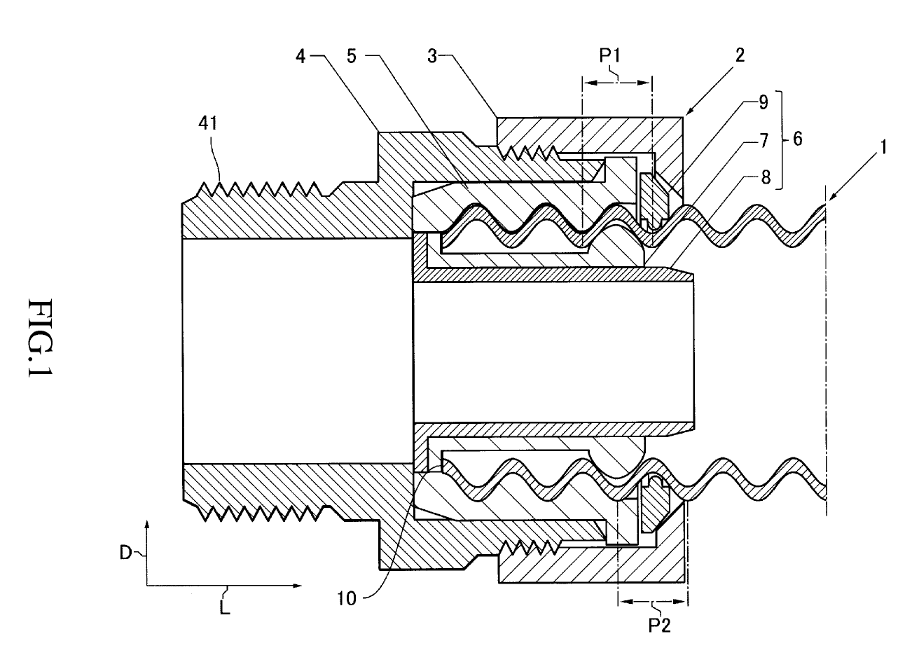

In FIGS. 1 to 8, the same reference signs indicate the same or corresponding features. In general, buildings are equipped with water supply systems for feeding water from distributing pipes buried under roads by water suppliers to owners of the buildings (consumers). The water supply systems each include feeding pipes branching from a distributing pipe and water fixtures directly connected to the feeding pipes. For example, water from the distributing pipe flows through the feeding pipes arranged in a building to water fixtures such as faucets.

In recent years, the feeding pipes have been flexible corrugated pipes. Such flexible corrugated pipes can be readily bent and can thus be efficiently arranged in a desired feeding-pipe formation. The arrangement of feeding pipes requires the connection of multiple corrugated pipes on the basis of specific conditions, such as the structure and the scale of the building.

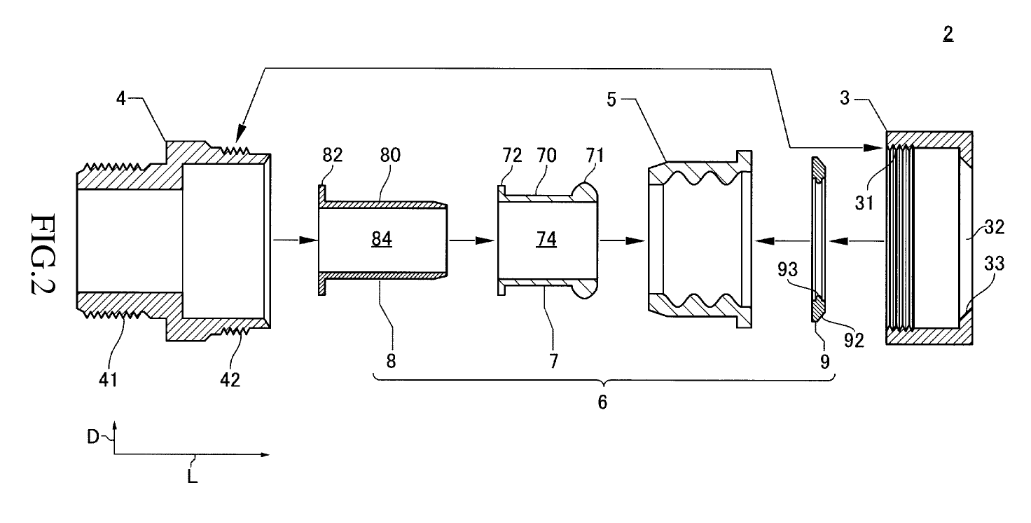

FIG. 1 illustrates a pipe joint according to an embodiment of the invention attached to a connecting end 10 of a corrugated pipe 1 during the connection of multiple corrugated pipes. The pipe joint 2 according to the embodiment illustrated in FIGS. 1 and 2 includes a nut 3, a socket 4, and a gasket 5. The corrugated pipe 1, the nut 3, the socket 4, and the gasket 5 are well known in the art and will be briefly described below.

The corrugated pipe 1 is fabricated through the uniform corrugation on a stainless-steel pipe. The corrugated pipe 1 illustrated in FIG. 1 has a connecting end 10, and is attached via the nut 3 to the socket (coupling component) 4. The corrugated pipe 1 is further provided with another pipe joint 2 at the other end to be connected to other pipes, which feature is not depicted in FIG. 1.

The nut 3 is attached on the outer surface of the corrugated pipe 1. The nut 3 illustrated in FIGS. 1 and 2 is a cap nut. The cap nut 3 has an internal thread 31 on the inner surface at one end (closer to the socket 4) to be screwed to the socket 4, and an opening 32 at the other end (inner end) to receive the corrugated pipe 1 therein. The edge around the opening 32 has an oblique surface 33 flaring toward the socket 4. The nut 3 is attached on the outer surface of the corrugated pipe 1 such that the opening 32 receives the connecting end 10.

The socket 4 has an external thread 41 on the outer surface at one end to be screwed to a nut of other pipe or a cap (not shown), and an external thread 42 on the outer surface at the other end (closer to the nut 3). The external thread 42 is screwed to the internal thread 31, so that the socket 4 is coupled to the nut 3 and is thus attached on the outer surface of the corrugated pipe 1. The gasket 5 is disposed between the inner surface of the socket 4 and the outer surface of the corrugated pipe 1 to prevent water leakage.

The above-described structure is also employed in traditional pipe joints. Unfortunately, the traditional pipe joints cannot prevent accidental disconnection of the pipe joint 2 from the flexible corrugated pipe 1. As described above, the disconnection is caused by an unintentional deformation of the corrugated pipe 1 caused by tensile force, for example, in response to a distortion of the building during an earthquake, which leads to the stretch of the corrugated wall of the pipe 1 in the axial direction L and then a reduction in diameter of the pipe 1.

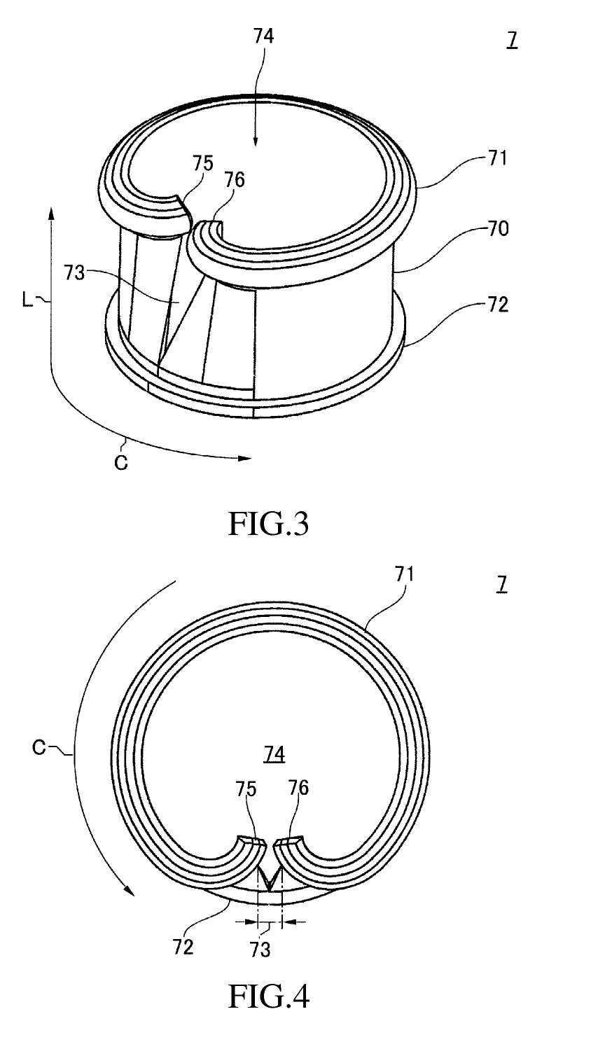

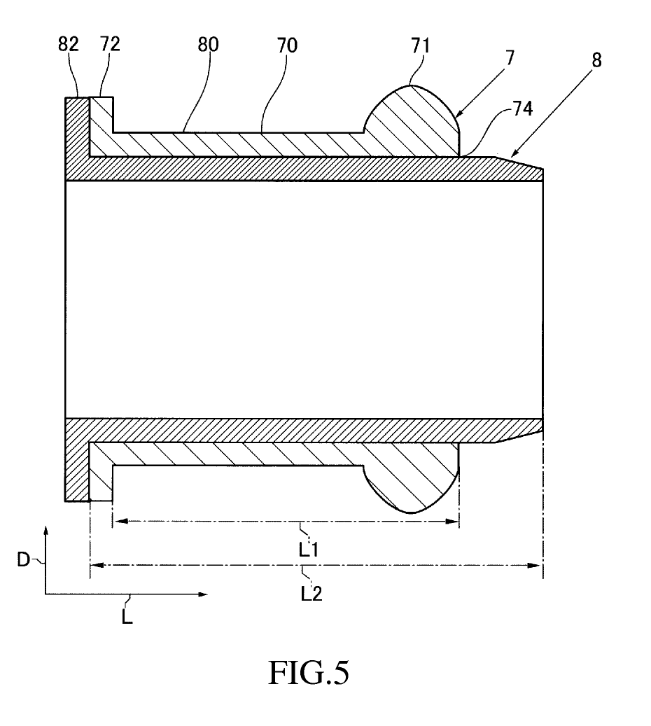

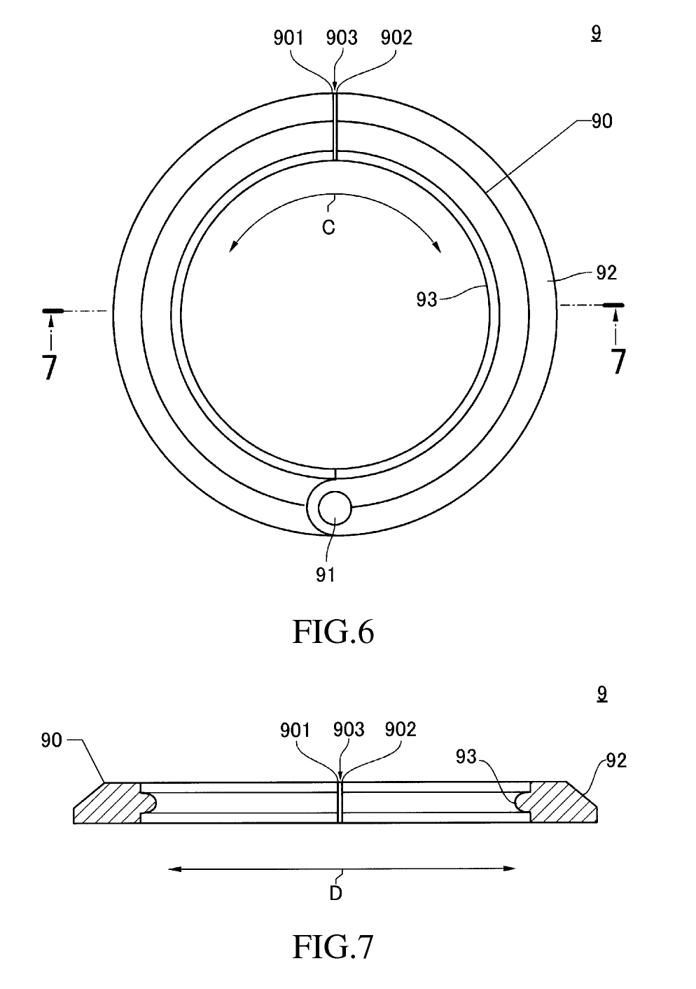

The invention can provide a pipe-joint holding unit 6 to prevent such an unintentional deformation of the corrugated pipe 1 and thus accidental disconnection of the pipe joint 2. The holding unit 6 illustrated in FIGS. 1 and 2 includes a first holder 7 (refer to FIGS. 3 and 4), a second holder 8 (refer to FIG. 5), and a third holder 9 (refer to FIGS. 6 and 7). The holding unit 6 is disposed between the nut 3 and the socket 4.

The first holder 7 is a retainer including a ring segment received on the inner surface of a protrusion P1 of a corrugated pipe 1. The first holder 7 illustrated in FIGS. 1 to 5 includes a cylindrical base 70, a ridge 71, a flange 72, and a notch 73. The cylindrical base 70 has a circular cross-section and has an opening 74 extending through the cylindrical base 70 in the axial direction L.

The ridge 71 protrudes from the outer surface of the cylindrical base 70 at one end of the cylindrical base 70 in the axial direction L. The ridge 71 protrudes in the radial direction D crossing the outer surface of the cylindrical base 70 and forms a ring extending in the circumferential direction C of the cylindrical base 70. The ridge 71 has a profile along the inner surface of a protrusion P1 of the corrugated pipe 1, i.e., along a space defined by the line connecting the bottoms of two adjacent depressions and the inner surface of the protrusion P1.

The flange 72 protrudes from the outer surface of the cylindrical base 70 at the end of the cylindrical base 70 opposite to the ridge 71 in the axial direction L. The flange 72 protrudes in the radial direction D and forms a ring extending in the circumferential direction C.

The first holder 7 is attached to the corrugated pipe 1 by inserting the cylindrical base 70 in the corrugated pipe 1 from its connecting end 10, such that the ridge 71 is received on the inner surface of the protrusion P1, and the flange 72 abuts on the connecting end 10. The length L1 of the cylindrical base 70 illustrated in FIG. 5 in the axial direction L, more accurately, the length L1 from the flange 72 to the ridge 71 is determined based on the position of the protrusion P1 to receive the ridge 71. The length L1 should preferably be determined such that the ridge 71 is received in the protrusion P1 while the flange 72 abuts on the connecting end 10. For example, in order to dispose the ridge 71 in the third protrusion P1 from the connecting end 10, the length L1 is preliminarily determined to be equal to the distance from the connecting end 10 to the third protrusion P1.

The first holder 7 is composed of a synthetic resin, such as polyoxymethylene (POM) or polyamide (PA), in terms of corrosion resistance, flexibility, resilience, readiness to processing, and material costs. The first holder 7 can be fabricated by molding such a synthetic resin through a well-known molding process. The cylindrical base 70, the ridge 71, and the flange 72 should preferably be integrally molded.

The first holder 7 further has a notch 73. The notch 73 is a slit extending in the cylindrical base 70 along its axial direction L. The notch 73 illustrated in FIGS. 3 and 4 extends from the boundary between the flange 72 and the cylindrical base 70 or the vicinity thereof, to the external end of the ridge 71 along the axial direction L of the cylindrical base 70 in a tapered or triangle form. In other words, the notch 73 cuts in the ridge 71 of the first holder 7 such that cut ends 75 and 76 face each other via the notch 73. The cut ends 75 and 76 should preferably curve toward the axial direction L of the cylindrical base 70.

The second holder 8 serves as a core of the first holder 7. The second holder 8 includes a cylindrical base 80 and a flange 82 and is disposed in the first holder 7. In the second holder 8 illustrated in FIG. 5, the cylindrical base 80 has a circular cross-section and has an opening 84 extending through the cylindrical base 80 in the axial direction L. The opening 84 of the second holder 8 inserted in the corrugated pipe 1 from the connecting end 10 functions as a fluid passage for tap water flowing in the corrugated pipe 1.

The flange 82 protrudes from the outer surface of the cylindrical base 80 at the end of the cylindrical base 80 opposite to the inserting end in the axial direction L. The flange 82 protrudes in the radial direction D and forms a ring extending in the circumferential direction C.

The second holder 8 is composed of a metal such as stainless steel, like the corrugated pipe 1, in terms of corrosion resistance and stiffness. The second holder 8 can be fabricated through a well-known metal forming process. The cylindrical base 80 and the flange 82 should preferably be integrally formed.

The cylindrical base 80 of the second holder 8 is removably disposed in the first holder 7 at the connecting end 10 (refer to FIG. 5). The length L2 of the cylindrical base 80 in the axial direction L is longer than the length L1 of the first holder 7. The second holder 8 is disposed in the first holder 7, such that the inserting end of the cylindrical base 80 protrudes from the ridge 71 in the axial direction L and the cylindrical base 80 supports the inner surface of the ridge 71. In other words, the first holder 7 and the second holder 8 disposed in the corrugated pipe 1 cooperate to serve as a double-cylinder internal stopper.

The length of the flange 82 in the radial direction is substantially equal to that of the flange 72. In the cylindrical base 80 disposed in the first holder 7, the flange 82 abuts on the flange 72. The flanges 72 and 82 are disposed between the corrugated pipe 1 and the socket 4 and are tightly held between the connecting end 10 and the inner surface of the socket 4.

The third holder 9 is a stopper ring to prevent the disconnection of the nut 3. The third holder 9 illustrated in FIGS. 6 and 7 includes a ring base 90, a screwed link 91, an oblique surface 92, and a ridge 93. The ring base 90 is an open ring consisting of two arc segments having respective ends 901 and 902. The two arc segments are movably coupled to each other with the screwed link 91. The screwed link 91 should preferably hold the two arc segments such that the ends 901 and 902 are not in contact with each other, while the ring base 90 in a closed state has a substantially circular shape in plan view. In other words, the screwed link 91 forms a slit 903 in the closed ring base 90 having a substantially circular shape in plan view. The slit 903 extends between the opposite ends 901 and 902 of the two arc segments in the radial direction D and the ring base 90 is openable and closable in the circumferential direction C.

The oblique surface 92 flares from the top toward the bottom of the ring base 90. The ridge 93 protrudes from the inner surface of the ring base 90 in the radial direction D crossing the inner surface and forms a ring extending in the circumferential direction C.

With reference to FIGS. 1 to 7, the third holder 9 is disposed outside the protrusion P1 of the corrugated pipe 1 that receives the ridge 71, and holds the corrugated pipe 1 on both surfaces against the ridge 71. The third holder 9 is fitted around a depression P2 adjacent to the protrusion P1, such that the ring base 90 and the ridge 93 are received in the depression P2. The oblique surface 92 protrudes from the depression P2 that receives the third holder 9 to be in contact with the oblique surface 33 of the nut 3. The contact of the oblique surface 92 with the oblique surface 33 and the screwing of the nut 3 to the socket 4 can engage the third holder 9 with the nut 3 between the corrugated wall of the pipe 1 and the oblique surface 33.

In the measures for preventing water leakage in such water supply systems, earthquakes are seriously problematic. Most of the distributing pipes are under the management of water suppliers and are prepared by them for earthquakes, whereas most of the feeding pipes are under the management of consumers and are not fully prepared for earthquakes. For example, in the case of accidental disconnection of a pipe joint from a feeding pipe in response to a distortion of the building during an earthquake, consumers cannot receive water despite of no water leakage in distributing pipes. Furthermore, since the feeding pipes are often arranged inside walls or beneath the floor of the building, it takes a long time to specify the position of the disconnected pipe joints from outside the walls or above the floor and to reconnect the feeding pipes.

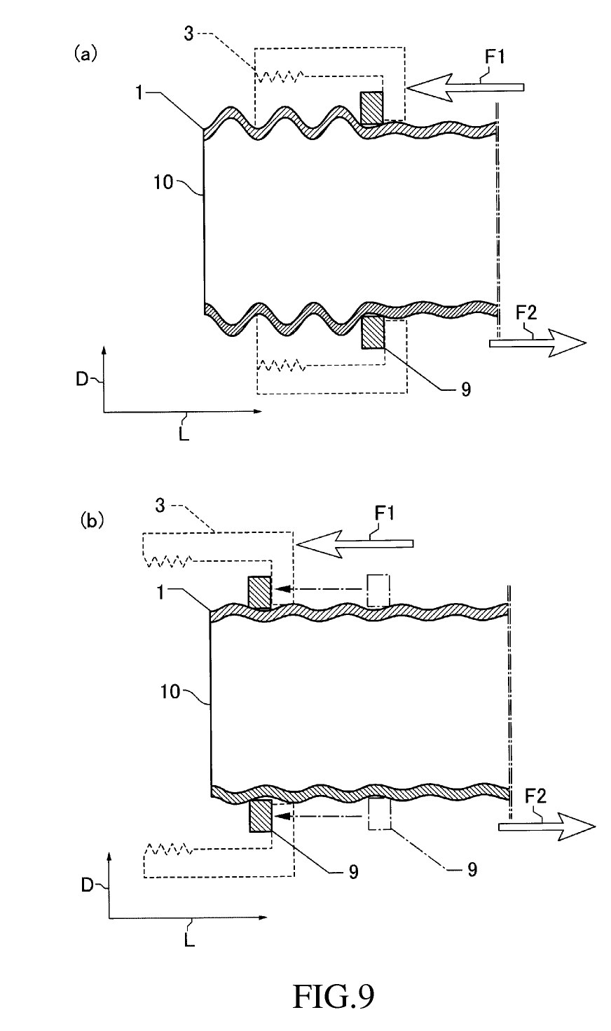

Unfortunately, traditional pipe joints cannot prevent such accidental disconnection because a nut 3 is fixed with a stopper ring 9 alone. In specific, with reference to FIG. 9 (a), the flexible corrugated pipe 1 is unintentionally deformed by tensile force F1 on the nut 3 or tensile force F2 on the corrugated pipe 1, so that part of the corrugated wall of the pipe 1 extending from the stopper ring 9 toward the center is stretched out in the axial direction L, leading to a reduction in diameter of the pipe 1. At the limit of the unintentional deformation, the stopper ring 9 is drawn toward the connecting end 10 by the tensile force F1 or F2 concentrated on the stopper ring 9, while deforming the corrugated wall of the pipe 1, as illustrated in FIG. 9(b). Accordingly, the stopper ring 9, the nut 3 engaging with the stopper ring 9, and the socket 4 coupled to the nut 3 are all disconnected from the connecting end 10.

In contrast, the holding unit 6 and the pipe joint 2 including the holding unit 6, described with reference to FIGS. 1 to 7, can avoid the trouble. In specific, the first holder 7 has a ridge 71 protruding from the outer surface of the cylindrical base 70 at one end of the cylindrical base 70 in the axial direction L. The ridge 71 has a profile along the space within a protrusion P1 of the corrugated pipe 1. The ridge 71 can thus be received on the inner surface of the protrusion P1 of the corrugated pipe 1.

The first holder 7 having the ridge 71 received in the protrusion P1 and the second holder 8 inserted in the first holder 7 and supporting the inner surface of the first holder 7 cooperate to serve as a double-cylinder internal stopper. The third holder 9 is fitted around the depression P2 adjacent to the protrusion P1, such that the ring base 90 and the ridge 93 are received in the depression P2. In other words, the third holder 9 serves as an external stopper functioning together with the first and second holders 7 and 8.

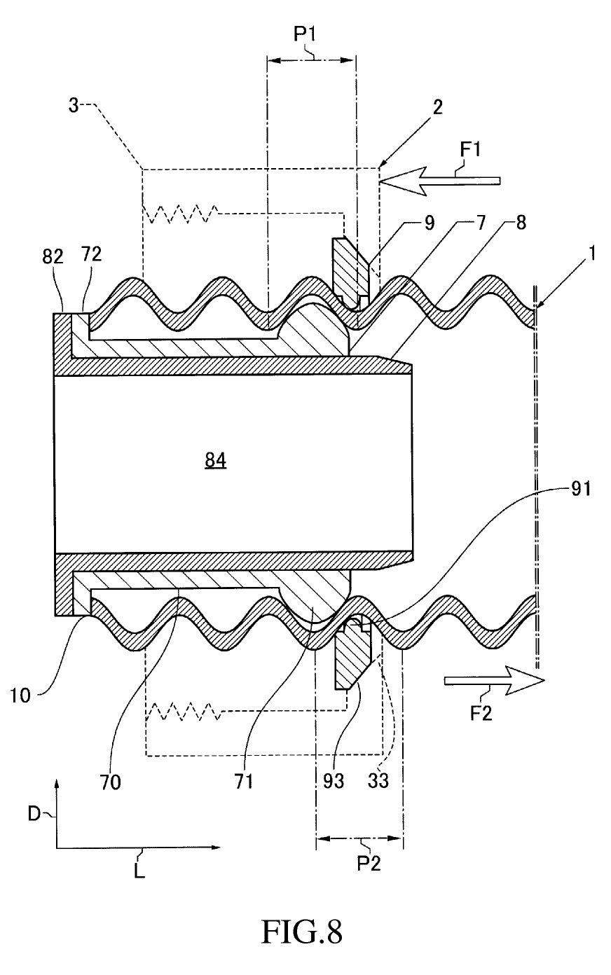

In the unit of the first, second, and third holders 7, 8, and 9, the support by the ridge 71 can prevent an unintentional deformation of the corrugated wall of the pipe 1 by tensile force F1 or F2 applied to the corrugated wall via the third holder 9, as illustrated in FIG. 8. Accordingly, this unit can prevent accidental disconnection of the pipe joint 2 and thus water leakage.

In the double-cylinder internal stopper, the second holder 8 resides in the first holder 7 to support the inner surface of the first holder 7. The second holder 8 can thus prevent an unintentional deformation of the ridge 71 by the tensile force F1 or F2.

The first holder 7 has the cylindrical base 70 inserted in the corrugated pipe 1 from the connecting end 10 such that the flange 72 abuts on the connecting end 10. The flange 72 can thus prevent the first holder 7 from being entirely thrust into the corrugated pipe 1. In addition, the flange 72 can protect a worker in an assembling operation from injury. In specific, the connecting end 10 of the corrugated pipe 1 is processed with a cutting machine and thus has a sharp edge, which often hurts the worker in the assembling operation. The flange 72 of the first holder 7 can protect the worker from such injury by preventing a direct contact of a palm of the worker with the sharp connecting end 10, for example, during the insertion of the first holder 7 with the palm.

The cylindrical base 70 of the first holder 7 is inserted in the corrugated pipe 1 from the connecting end 10, such that the ridge 71 is received in the protrusion P1 and the flange 72 abuts on the connecting end 10. In other words, the length L1 of the cylindrical base 70 is determined based on the position of the protrusion P1 to receive the ridge 71, such that the ridge 71 is received in the protrusion P1 and the flange 72 abuts on the connecting end 10. The preliminary determination of the length L1 of the cylindrical base 70 can dispose the ridge 71 in a desired protrusion P1. The first holder 7 can thus be efficiently and accurately aligned to a proper position.

The first holder 7 has a notch 73 extending in the cylindrical base 70 along its axial direction L. The notch 73 can facilitate the insertion of the first holder 7 in the corrugated pipe 1 and the introduction of the ridge 71 into the protrusion P1. In specific, the pipe 1 has a corrugated wall having depressions defining the minimum inner diameter and protrusions defining the maximum inner diameter of the pipe 1. If the first holder 7 has no notch 73, the cylindrical base 70 cannot enter the corrugated pipe 1 because the ridge 71 collides against the depressions.

The first holder 7, which is composed of a flexible synthetic resin and has a notch 73, can be squeezed into the corrugated pipe 1, for example, through warping the cut ends 75 and 76 inward with fingers of the worker to temporarily reduce the diameters of the ridge 71 and the cylindrical base 70. The first holder 7 inserted in the corrugated pipe 1 then restores the original shape because of its resilience in response to the release of the fingers from the first holder 7, so that the ridge 71 can be received in the protrusion P1.

The protruding length of the flange 82 is substantially equal to that of the flange 72. The worker can insert the first holder 7 such that the flange 72 abuts on the connecting end 10 and then insert the second holder 8 in the opening 74. This operation can attach the second holder 8 to the first holder 7 and the connecting end 10.

Even if the first holder 7 is slightly deviated from a proper position, the first holder 7 is pushed to a proper position by the flange 82 abutting on the flange 72 during the insertion of the second holder 8. The first and second holders 7 and 8 can thus be aligned to proper positions inside the corrugated pipe 1.

The flange 82 overlying the flange 72 can prevent a direct contact of a palm of the worker with the connecting end 10 of the corrugated pipe 1, for example, during an inserting operation with the palm, and thus can protect the worker from injury.

The third holder 9 is received in the depression P2 and holds the corrugated pipe 1 on both surfaces against the ridge 71. The ridge 93 protrudes from the inner surface of the ring base 90 in the radial direction D and forms a ring extending in the circumferential direction C. The ridge 93 received in the depression P2 can thus support the outer surface of the depression P2.

The ring base 90, which is an open ring, consists of two arc segments movably coupled to each other with the screwed link 91. The slit 903 extends between the ends 901 and 902 of the two arc segments in the radial direction D and the ring base 90 is openable and closable in the circumferential direction C. The ring base 90 is opened at the slit 903 to receive the corrugated pipe 1 in the third holder 9, and is then closed to fit the third holder 9 on the outer surface of the corrugated pipe 1.

The third holder 9 is fitted such that the oblique surface 92 protrudes from the depression P2 to be in contact with the oblique surface 33 of the nut 3. The contact of the oblique surface 92 with the oblique surface 33 of the nut 3 and the screwing of the nut 3 to the socket 4 can engage the third holder 9 with the nut 3 between the corrugated wall of the pipe 1 and the oblique surface 33. The diameter of the third holder 9 is reduced, for example, in response to the tensile force F1 applied to the nut 3, because of sliding of the oblique surface 92 on the oblique surface 33. The fastening force of the third holder 9 onto the corrugated pipe 1 increases in proportion to the tensile force F1. This configuration can thus avoid accidental disconnection of the nut 3 and the pipe joint 2.

It is apparent to those skilled in the art that the above-described preferred embodiments of the invention may be modified in various manners on the basis of the basic technical idea and teaching of the invention. For example, the first holder 7 may be an open cylinder having a C shape in plan view, and have cut ends 75 and 76 completely separated from each other by a linear notch 73 having a substantially constant width and extending from one end to the other end of the cylindrical base 70 along its axial direction L. In this configuration, the worker can also narrow the gap between the cut ends 75 and 76 (the width of the notch 73) through pushing the side wall of the cylindrical base 70 inward in the radial direction. The diameters of the ridge 71 and the cylindrical base 70 can thus be temporarily reduced to squeeze the first holder 7 into the corrugated pipe 1.

The ring base 90 of the third holder 9 is not necessarily composed of two arc segments movably coupled to each other with the screwed link 91, and may be replaced with any ring base being an open ring and having a slit 903 for coupling the third holder 9 to the corrugated pipe 1.

### REFERENCE SIGNS LIST

1 corrugated pipe
2 pipe joint
3 nut
4 socket
6 holding unit
7 first holder
70 cylindrical base
71 ridge (ring segment)
8 second holder
9 third holder

1. A pipe-joint holding unit for use in a pipe joint for a corrugated pipe, the unit comprising:
a first holder having a cylindrical base, a ridge, and a notch, wherein
the ridge comprises a synthetic resin resistant to deformation by external tensile force, the ridge protruding from the outer surface of the cylindrical base, the ridge being received on the inner surface of a protrusion of the corrugated pipe, and
the notch extends along an axial direction of the cylindrical base.

2. A pipe-joint holding unit for use in a pipe joint for a corrugated pipe, the unit comprising:
a first holder having a ring segment; and
a third holder, wherein
the ring segment comprises a synthetic resin resistant to deformation by external tensile force, the ring segment being received on the inner surface of a protrusion of the corrugated pipe,
the third holder comprising a ring received in a depression adjacent to the protrusion receiving the first holder, and
the first holder and the third holder hold the corrugated pipe on the inner surface and the outer surface of the corrugated pipe.

3. The pipe-joint holding unit according to claim 2, further comprising a second holder comprising a cylinder disposed in the first holder.

4. A pipe-joint holding unit for use in a pipe joint for a corrugated pipe, the unit comprising:
a first holder having a cylindrical base and a ridge; and
a third holder, wherein
the ridge comprises a synthetic resin resistant to deformation by external tensile force, the ridge protruding from the outer surface of the cylindrical base, the ridge being received on the inner surface of a protrusion of the corrugated pipe,
the third holder comprising a ring received in a depression adjacent to the protrusion receiving the first holder, and
the first holder and the third holder hold the corrugated pipe on the inner surface and the outer surface of the corrugated pipe.

5. The pipe-joint holding unit according to claim 4, further comprising a second holder comprising a cylinder disposed in the first holder.
